(19) United States
(12) Patent Application Publication
(10) Pub. No.: US 2007/0047219 A1
(43) Pub. Date: Mar. 1, 2007

(54) DIRECT-LIT BACKLIGHT HAVING LIGHT SOURCES WITH BIFUNCTIONAL DIVERTERS

(75) Inventors: David Scott Thompson, Woodbury, MN (US); Craig R. Schardt, St. Paul, MN (US); Torren R. Carlson, Minneapolis, MN (US); Gregory G. Jager, Woodbury, MN (US); John A. Wheatley, Lake Elmo, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/458,891

(22) Filed: Jul. 20, 2006

Related U.S. Application Data
(60) Provisional application No. 60/711,522, filed on Aug. 27, 2005.

(51) Int. Cl. G09F 13/04

(52) U.S. Cl. 362/97

(57) ABSTRACT

Direct-lit light backlights and associated methods and components are disclosed. The backlight has an output area such as a front diffuser behind which a plurality of light sources are disposed. A diverter having a first and second reflective surface is disposed between at least two light sources and the front diffuser. The first reflective surface is obliquely disposed to redirect at least some of the light emitted by the light source towards the front diffuser away from the front diffuser. The second reflective surface is obliquely disposed to redirect at least some light propagating laterally relative to the front diffuser towards the front diffuser.

### CROSS REFERENCE TO RELATED APPLICATIONS

This application claims the benefit under 35 USC § 119(e) of U.S. provisional application Ser. No. 60/711,522, filed Aug. 27, 2006.

### FIELD OF THE INVENTION

The present invention relates to backlights, particularly direct-lit backlights, as well as to components used in backlights, systems that use backlights, and methods of making and using backlights. The invention is particularly well suited to backlights used in liquid crystal display (LCD) devices and similar displays, as well as to backlights that utilize LEDs as a source of illumination.

### BACKGROUND

Recent years have seen tremendous growth in the number and variety of display devices available to the public. Computers (whether desktop, laptop, or notebook), personal digital assistants (PDAs), mobile phones, and thin LCD TVs are but a few examples. Although some of these devices can use ordinary ambient light to view the display, most include a light panel referred to as a backlight to make the display visible.

Many such backlights fall into the categories of “edge-lit” or “direct-lit”. These categories differ in the placement of the light sources relative to the output area of the backlight, where the output area defines the viewable area of the display device. In edge-lit backlights, a light source is disposed along an outer border of the backlight construction, outside the zone corresponding to the output area. The light source typically emits light into a light guide, which has length and width dimensions on the order of the output area and from which light is extracted to illuminate the output area. In direct-lit backlights, an array of light sources is disposed directly behind the output area, and a diffuser is placed in front of the light sources to provide a more uniform light output. Some direct-lit backlights also incorporate an edge-mounted light, and are thus capable of both direct-lit and edge-lit operation.

It is known for direct-lit backlights to use an array of cold cathode fluorescent lamps (CCFLs) as the light sources. It is also known to place a diffuse white reflector as a back reflector behind the CCFL array, to increase brightness and presumably also to enhance uniformity across the output face.

Recently, liquid crystal display television sets (LCD TVs) have been introduced that use a direct-lit backlight powered not by CCFLs but by an array of red/green/blue LEDs. An example is the Sony™ Qualia 005 LED Flat-Screen TV. The 40 inch model uses a direct-lit backlight containing five horizontal rows of side-emitting Luxeon™ LEDs, each row containing 65 such LEDs arranged in a GRBRG repeating pattern, and the rows being spaced 3.25 inches apart. This backlight is about 42 mm deep, measured from the front of a diffuse white back reflector to the back of a (about 2 mm thick) front diffuser, between which is positioned a flat transparent plate having an array of 325 diffuse white reflective spots. Each of these spots, which transmit some light, is aligned with one of the LEDs to prevent most of the on-axis light emitted by the LED from striking the front diffuser directly. The back reflector is flat, with angled sidewalls.

### BRIEF SUMMARY

The present application discloses, inter alia, direct-lit backlights that include at least a first and second light source spaced apart from each other and each emitting a first light component in a forward direction towards an output area of the backlight. The backlight also includes a first diverter disposed between the light sources and the output area, the diverter having a first and second reflective surface. The first reflective surface is obliquely disposed to redirect at least some of the first light components from the light sources away from the output area, and the second reflective surface is obliquely disposed to redirect at least some of a second light component propagating laterally relative to the output area towards the output area.

The backlight can include a back reflector and reflective side walls which, together with the output surface, can define a backlight cavity within which the diverter is disposed. The first and second light sources can be discrete light sources such as LEDs, and can form a row of discrete light sources together with other discrete light sources, in some embodiments the different light sources having different emitted colors which may blend to produce white light at the output area.

The diverter can be or comprise an elongated body that snaps in place within a backlight enclosure, optionally spanning an entire dimension (length or width) of the output area and disposed to be suspended over a row of LED or other discrete light sources. In some cases a narrow linear source such as a fluorescent lamp (e.g. a CCFL) can be substituted for the row or plurality of discrete light sources.

Associated components, systems, and methods are also disclosed.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a perspective exploded view of a display system that includes a backlight;

FIG. 1a is a view similar to FIG. 1 but also showing in phantom the location of discrete light sources disposed behind the output area of the backlight;

FIG. 2 is a schematic side elevational view of one backlight that utilizes diverters;

FIG. 3 is a schematic side elevational view of another backlight, one that utilizes bifunctional diverters;

FIG. 3a is a schematic plan view of the backlight of FIG. 3 along line 3a-3a;

FIGS. 4a-i are schematic cross-sectional views of different bifunctional diverters in combination with one or more light sources; and

FIGS. 5-8 are views of various packaged LEDs useable as light sources in the disclosed backlights.

### DETAILED DESCRIPTION OF THE ILLUSTRATIVE EMBODIMENTS

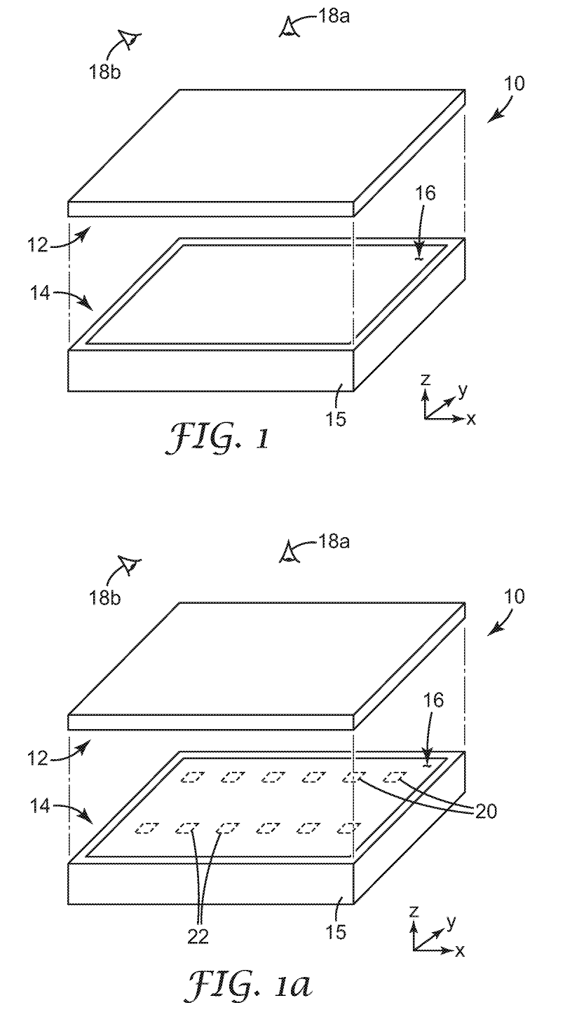

One popular application of a backlight is shown schematically in the perspective exploded view of FIG. 1. There, a display system 10 includes a display panel 12, such as a liquid crystal display (LCD) panel, and a direct-lit backlight 14 that provides large area illumination sufficient for information contained in the display panel to be easily observed. Both display panel 12 and backlight 14 are shown in simplified box-like form, but the reader will understand that each contains additional detail. Backlight 14 emits light over an extended output area 16, and may also include a frame 15. The output area 16, which is usually rectangular but can take on other extended area shapes as desired, may correspond to the outer surface of a film used in the backlight, or may simply correspond to an aperture in the frame 15. In operation, the entire output area 16 is illuminated by light source(s) disposed within frame 15 but positioned directly behind the output area 16. When illuminated, the backlight 14 makes visible for a variety of observers 18a, 18b an image or graphic provided by display panel 12. In the case of an LCD panel, the image or graphic is dynamic, produced by an array of typically thousands or millions of individual picture elements (pixels), which array substantially fills the lateral dimensions, i.e. the length and width, of the display panel 12. In other embodiments the display panel may be or comprise a film having a static graphic image printed thereon. FIG. 1 also includes a Cartesian x-y-z coordinate system for reference purposes.

In some LCD embodiments, the backlight 14 continuously emits white light and the pixel array is combined with a color filter matrix to form groups of multicolored pixels (such as yellow/blue (YB) pixels, red/green/blue (RGB) pixels, red/green/blue/white (RGBW) pixels, red/yellow/green/blue (RYGB) pixels, red/yellow/green/cyan/blue (RYGCB) pixels, or the like) so that the displayed image is polychromatic. Alternatively, polychromatic images can be displayed using color sequential techniques, where, instead of continuously back-illuminating the display panel with white light and modulating groups of multicolored pixels in the display panel to produce color, separate differently colored light sources within the backlight itself (selected, for example, from red, orange, amber, yellow, green, cyan, blue (including royal blue), and white in combinations such as those mentioned above) are modulated such that the backlight flashes a spatially uniform colored light output (such as, for example, red, then green, then blue) in rapid repeating succession. This color-modulated backlight is then combined with a display module that has only one pixel array (without any color filter matrix), the pixel array being modulated synchronously with the backlight to produce the whole gamut of achievable colors (given the light sources used in the backlight) over the entire pixel array, provided the modulation is fast enough to yield temporal color-mixing in the visual system of the observer. Examples of color sequential displays, also known as field sequential displays, are described in U.S. Pat. No. 5,337,068 (Stewart et al.) and U.S. Pat. No. 6,762,743 (Yoshihara et al.), hereby incorporated by reference. In some cases, it may be desirable to provide only a monochrome display. In those cases the backlight 14 can include filters or specific sources that emit predominantly in one visible wavelength or color.

The display system 10 is shown again in FIG. 1a, with FIG. 1a additionally showing in phantom a first row of discrete light sources 20 and a second row of discrete light sources 22 within the direct-lit backlight 14. The light sources 20, 22 may each emit white light, or may each emit only one of the RYGCB colors and then either be mixed to provide a white light output or be matched to provide a monochrome output. The sources 20 and 22 are disposed directly behind the output area 16.

A challenge facing backlight designers, and in particular designers of direct-lit backlights, is making a backlight with sufficient brightness and uniformity, but in a package that is as thin as possible. As the backlight is made thinner and thinner, the light sources are disposed closer and closer to the output area, which is often a front diffuser plate or light control film stack, producing bright spots or lines at the output area (and similar spots or lines visible on the display panel) in localized regions just above the light sources.

One way of dealing with this challenge is to use side-emitting light sources in the backlight. In contrast to Lambertian sources, which have a peak light emission in a forward direction substantially perpendicular to the output area (typically along a symmetry axis of the light source), side-emitters have a peak light emission in a lateral direction oblique to the output area, sometimes approximately parallel to the output area (and perpendicular to a symmetry axis of the light source) and sometimes in a substantially backwards direction (opposite the forward direction). Exemplary side-emitters are LEDs that are packaged with an integral lens component that redirects light from the LED die laterally relative to a symmetry axis of the packaged LED. Note that although side-emitting light sources have a peak emission in a lateral direction, in some cases they can also have a significant emission in a forward direction perpendicular to the output area.

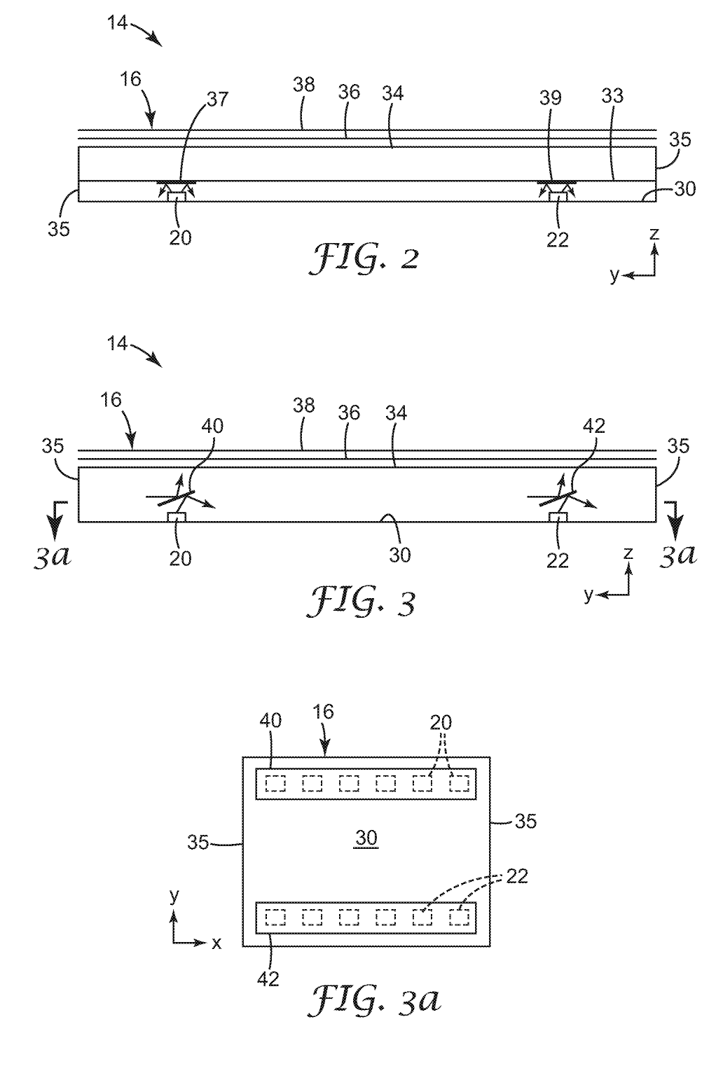

Another way of dealing with the challenge is to use diverters in combination with the light sources. FIG. 2 shows one example of how backlight 14 can incorporate diverters. The backlight has a back reflector 30 at a rear portion thereof and typically light management films or other components, such as a diffuser plate or film 34 and a top film stack comprising conventional light management films such as a reflective polarizer 36 and a prismatic brightness enhancement film 38, at a front portion. The output area 16 is shown in this case to correspond to the outermost light management film 38, but in other embodiments it can correspond to a diffuser plate. In the cavity formed between the back reflector and the output area, the discrete light sources 20, 22 are disposed. The placement of the sources 20, 22 directly behind the output area 16 is consistent with the backlight 14 being of the direct-lit variety. For efficiency, reflective side walls such as opposed side walls 35, 35 are also provided in the cavity, around the boundary of the output area 16. The same reflective material used for the back reflector can be used to form these walls, or a different reflective material can be used. In exemplary embodiments the side walls are diffusely reflective.

For source hiding purposes, the backlight further includes diverters 37, 39 proximate sources 20, 22 respectively. Each diverter is a row of reflective spots, with each spot being positioned in front of one of the sources. The diverters are held in position by a flat transparent support plate 33. As shown in the figure by the reflected light rays, diverters 37, 39 are effective to prevent forward-emitted light from the sources 20, 22 from directly striking the output area. However, depending on the proximity of the diffuser plate and any light management films, the diverters 37, 39 can block too much light and result in dark spots or lines at the output area proximate the light sources (and proximate the diverters).

FIG. 3 shows the backlight 14 configured with alternative light diverters 40, 42 disposed proximate sources 20, 22 respectively. Light diverters 40, 42 are bifunctional in that they not only redirect light emitted by the light sources in a forward direction towards the output area (i.e., parallel or nearly parallel with the z-axis) such that it is directed along a path away from the output area; they also redirect light that is propagating laterally within the cavity (i.e., parallel or nearly parallel with the x-y plane) such that it is directed along a path towards the output area. The former function prevents or reduces intense direct illumination at the output area in localized regions proximate the light sources, while the latter function promotes indirect illumination at the output area in those same localized regions, thus enhancing uniformity in low profile (thin) backlight designs. In FIG. 3, a lower reflective surface of light diverters 40, 42 is obliquely disposed to redirect all or at least a substantial portion of light emitted by the sources in a forward direction such that it is directed away from the output area (including in a lateral direction); an upper reflective surface of light diverters 40, 42 is obliquely disposed to redirect at least a substantial portion of laterally propagating light such that it is directed towards the output area. Of course, in this regard, “upper” and “lower” are terms of convenience used in connection with the perspective of the drawings, and are not intended to limit the orientation of the backlight in space relative to a gravitational field.

Each bifunctional diverter 40, 42 preferably takes the form of an elongated body disposed immediately above and parallel to two or more light sources that form a row of light sources, as shown in the plan view of FIG. 3a, where the rows of light sources and the diverters all extend parallel to the x-axis. In some embodiments the elongated bodies can be plastic bars or rods that can snap into place within the backlight cavity over the light sources by conventional mechanical fastening techniques.

The upper and lower reflective surfaces of the diverters can be predominantly specular, diffuse, or combination specular/diffuse reflectors, whether spatially uniform or patterned. The upper and lower reflective surfaces can have the same type of reflectivity, e.g., both can be specular reflectors or both can be diffuse reflectors, or they can have different types of reflectivity, e.g., one can be a specular reflector and one can be a diffuse reflector. The upper and lower reflective surfaces can be associated with different reflective films or layers, whether discontinuous or continuous, or they may correspond to opposed major surfaces of a single reflective film or layer, whether such film or layer is freestanding or disposed on a transparent substrate to permit optical access to both major surfaces. One or both of the reflective surfaces can be flat, curved, or compound in shape. In some cases one or both may also be partially transmissive. Preferably, however, they are both highly reflective, for example, at least 70%, 80%, 90%, or 95% or more. They can utilize the same reflective material as the back reflector (see discussion below regarding exemplary back reflector materials) and the side walls of the backlight cavity, or they can use different reflective materials.

In some embodiments, the reflective materials can be films with engineered surface structures that, when oriented at the appropriate angle with respect to the back reflector and/or light sources, are highly reflective. For example, the reflective material may be or comprise a film having a smooth or flat major surface opposite a structured surface, the structured surface having a large number of facets arranged to form prisms. The prisms may be linear, all extending parallel to a common in-plane direction, or they may be limited in extent along two orthogonal in-plane directions such that they form a two-dimensional array across the structured surface. Any of the Vikuiti™ brand Brightness Enhancement Film (BEF) products available from 3M Company may be used. A BEF linear prismatic film, for example, can be oriented to efficiently reflect by total internal reflection light emitted by a nearby light source in a forward direction perpendicular to the output area of the backlight, and to reflect less efficiently (and transmit more) light emitted at increasing angles to the forward direction or viewing axis of the backlight. This can be done by orienting the film so that the structured prismatic surface nominally faces a light source disposed directly beneath the film, but is tilted (e.g. by about 45 degrees) so that one face of each prism is approximately perpendicular to the forward direction, or approximately perpendicular to an axis extending from the light source to the prism face, or approximately parallel to the back reflector. Forward-propagating light enters such prism faces and reflects by total internal reflection from the opposed flat or smooth major surface of the film, whereupon it exits from another face of each prism. Light propagating at substantial angles to the forward direction can refract at a first prism face and then again at the opposed flat or smooth major surface of the film, thus being at least partially transmitted by the film. Regardless of the type of reflective material used, the diverters can be attached to either side of the frame (e.g., frame 15 of FIG. 2), or the back reflector (e.g., back reflector 30 of FIG. 3).

The reflective material of the diverter is preferably low loss at least over visible wavelengths, e.g., having a single-pass absorption of less than 5, 3, or 1% when averaged over the visible region. For diverters that utilize partially transmissive reflective material, the nature of the partial transmissivity can be of several types. In some cases, the reflector may be fabricated to reflect only some normally incident light, and transmit a substantial remaining portion of the light. Examples include weak reflectors, such as a metal vapor-coated surface where the metal layer is thin enough to transmit light, or a multilayer interference stack where the number of individual layers or optical repeat units is too small to provide high reflectivity for normally incident light. Further examples include reflective polarizers that transmit one polarization state (whether linear or circular) of normally incident light and reflect the orthogonal polarization state. Still other examples include patterned reflectors, such as where a transparent film is coated with a highly reflective material in isolated places forming a fine pattern, or perforated reflectors, such as a highly reflective multilayer polymeric film in which a plurality of fine holes or apertures have been formed to increase transmission. In other cases, the reflector may provide very high reflectivity for light of some incident directions but not for light of other incident directions. An example is the prismatic BEF film described above, or similar prismatic or structured surface films. Preferably, if a partially transmissive reflector is used as the diverter, it has a low loss (e.g. where percent transmission plus percent reflection is at least 95%, or 97%, or 99%) and it exhibits a percent transmission in a range from 20% to 80%. This 20-80% transmission range may be associated: (a) with light that is normally incident on the reflector, or (b) with light that is diffusely incident on the reflector, i.e., incident over a hemisphere of incident angles, and transmitted light is detected (the same as in condition (a)) over a hemisphere on the opposite side of the reflector, or (c) in the case of any given backlight design, with light from the light source closest to the diverter that actually impinges on the reflector. These testing conditions can be referred to as normal incidence, diffuse incidence, and actual incidence, respectively.

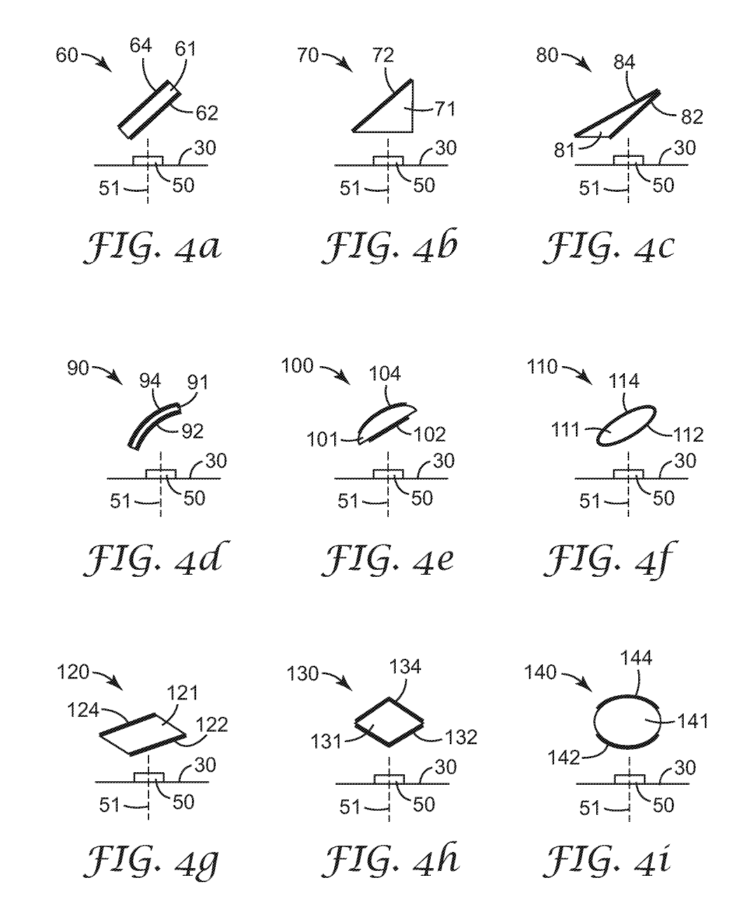

The lower reflective surface of a diverter can be oriented at an oblique angle with respect to the plane of the back reflector. If 0 degrees is defined as normal to plane of the back reflector and a diverter positioned vertically with respect to the backplane is a diverter positioned at 0 degrees, the diverter can tilt toward either sidewall with the angle between the diverter and normal being between 15 and 75 degrees or negative 15 and negative 75 degrees. In some embodiments, the angle between the diverter and normal can be between 35 and 70 degrees or negative 35 and negative 70 degrees. The angular orientation of the upper reflective surface of the diverters may be the same as that of the lower reflective surface, or it may have a different oblique angle. When the lower and upper reflective surfaces of the diverters are curved, as shown in some of the FIG. 4 embodiments below, the orientation of the reflective surfaces can be chosen to provide a uniform light output.

The light sources can be located inside the backlight cavity, or they can be positioned behind the back reflector 30 by translating them along the negative z direction, as long as back reflector 30 is provided with suitable apertures, such as corresponding holes, slots, windows, or other light-transmitting areas, so that light from the sources can still be directly injected into the cavities.

A given light source can be (1) an active component such as an LED die or fluorescent lamp that converts electricity to light or a phosphor that converts excitation light to emitted light, or (2) a passive component such as a lens, waveguide (such as a fiber), or other optical element that transports and/or shapes the light emitted by an active component, or (3) a combination of one or more active and passive components. For example, light sources 20, 22 in the figures may be packaged side-emitting LEDs in which an LED die is disposed behind the back reflector proximate a circuit board or heat sink, but a shaped encapsulant or lens portion of the packaged LED is disposed in the recycling cavity by extending through a slot or aperture in the back reflector.

The discrete light sources 20, 22 are shown schematically in the figures. In most cases, these sources are compact light emitting diodes (LEDs). In this regard, “LED” refers to a diode that emits light, whether visible, ultraviolet, or infrared. It includes incoherent encased or encapsulated semiconductor devices marketed as “LEDs”, whether of the conventional or super radiant variety. If the LED emits non-visible light such as ultraviolet light, and in some cases where it emits visible light, it is packaged to include a phosphor (or it may illuminate a remotely disposed phosphor) to convert short wavelength light to longer wavelength visible light, in some cases yielding a device that emits white light. An “LED die” is an LED in its most basic form, i.e., in the form of an individual component or chip made by semiconductor processing procedures. The component or chip can include electrical contacts suitable for application of power to energize the device. The individual layers and other functional elements of the component or chip are typically formed on the wafer scale, and the finished wafer can then be diced into individual piece parts to yield a multiplicity of LED dies. More discussion of packaged LEDs, including forward-emitting and side-emitting LEDs, is provided below.

If desired, other visible light emitters such as linear cold cathode fluorescent lamps (CCFLs) or hot cathode fluorescent lamps (HCFLs) can be used instead of or in addition to discrete LED sources as illumination sources for the disclosed backlights. For example, in some applications it may be desirable to replace the row of discrete light sources 20 seen in FIG. 1a with a different light source such as a long cylindrical CCFL, or with a linear surface emitting light guide emitting light along its length and coupled to a remote active component (such as an LED die or halogen bulb), and to do likewise with the row of discrete sources 22. Examples of such linear surface emitting light guides are disclosed in U.S. Pat. Nos. 5,845,038 (Lundin et al.) and 6,367,941 (Lea et al.). Fiber-coupled laser diode and other semiconductor emitters are also known, and in those cases the output end of the fiber optic waveguide can be considered to be a light source with respect to its placement in the disclosed backlight cavities or otherwise behind the output area of the backlight. The same is also true of other passive optical components having small emitting areas such as lenses, deflectors, narrow light guides, and the like that give off light received from an active component such as a bulb or LED die. One example of such a passive component is a molded encapsulant or lens of a side-emitting packaged LED.

Turning now to FIGS. 4a-i, we see there a small sample of the wide variety of different geometrical configurations with which one can construct suitable diverters. These figures are all cross-sectional representations of bifunctional diverters in combination with a light source 50 having a source axis 51 oriented perpendicular to the output area of the backlight. Back reflector 30 is also shown. Source 50 may be a row of discrete sources or a linear source extending perpendicular to the plane of the drawing. The diverters are also elongated in a direction perpendicular to the plane of the drawing.

FIG. 4a shows a diverter 60 having a diverter body 61 to which two reflective films 62, 64 have been applied. The lower surface of film 62 is obliquely disposed to redirect forward-emitted light from the source 50 laterally, and the upper surface of film 64 is obliquely disposed to redirect laterally propagating light upwards toward the output area of the backlight. In an alternative embodiment either film 62 or film 64 can be omitted, and opposed major surfaces of the remaining film can be used for the redirecting functions, provided diverter body 61 is transparent. Alternatively, both films 62, 64 can be omitted if diverter body 61 is composed of a highly reflective material, such as a diffuse white plastic material.

FIG. 4b shows a diverter 70 having a transparent diverter body 71 to which one reflective film 72 has been applied. The lower surface of film 72 is obliquely disposed to redirect forward-emitted light from the source 50 laterally, and the upper surface of film 72 is obliquely disposed to redirect laterally propagating light upwards toward the output area of the backlight.

FIG. 4c shows a diverter 80 having a diverter body 81 to which two reflective films 82, 84 have been applied. The lower surface of film 82 is obliquely disposed to redirect forward-emitted light from the source 50 laterally, and the upper surface of film 84 is obliquely disposed to redirect laterally propagating light upwards toward the output area of the backlight. One or both films 82, 84 can be omitted if diverter body 81 is composed of a highly reflective material, such as a diffuse white plastic material.

FIG. 4d shows a diverter 90 having a diverter body 91 to which two reflective films 92, 94 have been applied. The lower surface of film 92 is obliquely disposed to redirect forward-emitted light from the source 50 laterally, and the upper surface of film 94 is obliquely disposed to redirect laterally propagating light upwards toward the output area of the backlight. One or both films 92, 94 can be omitted if diverter body 91 is composed of a highly reflective material, such as a diffuse white plastic material.

FIG. 4e shows a diverter 100 having a diverter body 101 to which two reflective films 102, 104 have been applied. The lower surface of film 102 is obliquely disposed to redirect forward-emitted light from the source 50 laterally, and the upper surface of film 104 is obliquely disposed to redirect laterally propagating light upwards toward the output area of the backlight. One or both films 102, 104 can be omitted if diverter body 101 is composed of a highly reflective material, such as a diffuse white plastic material.

FIG. 4f shows a diverter 110 having a diverter body 111 to which two reflective films 112, 114 have been applied. Films 112, 114 are different portions of a continuous reflective film applied to the outer surface of the diverter body. The lower surface of film 112 is obliquely disposed to redirect forward-emitted light from the source 50 laterally, and the upper surface of film 114 is obliquely disposed to redirect laterally propagating light upwards toward the output area of the backlight. One or both films 112, 114 can be omitted if diverter body 111 is composed of a highly reflective material, such as a diffuse white plastic material.

FIG. 4g shows a diverter 120 having a diverter body 121 to which two reflective films 122, 124 have been applied. The lower surface of film 122 is obliquely disposed to redirect forward-emitted light from the source 50 laterally, and the upper surface of film 124 is obliquely disposed to redirect laterally propagating light upwards toward the output area of the backlight. One or both films 122, 124 can be omitted if diverter body 121 is composed of a highly reflective material, such as a diffuse white plastic material.

FIG. 4h shows a diverter 130 having a diverter body 131 to which two reflective films 132, 134 have been applied. The lower surface of film 132 is obliquely disposed to redirect forward-emitted light from the source 50 laterally, and the upper surface of film 134 is obliquely disposed to redirect laterally propagating light upwards toward the output area of the backlight. One or both films 132, 134 can be omitted if diverter body 131 is composed of a highly reflective material, such as a diffuse white plastic material.

FIG. 4i shows a diverter 140 having a diverter body 141 to which two reflective films 142, 144 have been applied. The lower surface of film 142 is obliquely disposed to redirect forward-emitted light from the source 50 laterally, and the upper surface of film 144 is obliquely disposed to redirect laterally propagating light upwards toward the output area of the backlight. One or both films 142, 144 can be omitted if diverter body 141 is composed of a highly reflective material, such as a diffuse white plastic material.

Back reflector 30 is preferably highly reflective for enhanced panel efficiency. For example, the back reflector may have an average reflectivity for visible light emitted by the light sources of at least 90%, 95%, 98%, or 99% or more. The back reflector can be a predominantly specular, diffuse, or combination specular/diffuse reflector, whether spatially uniform or patterned. In some cases the back reflector can be made from a stiff metal substrate with a high reflectivity coating, or a high reflectivity film laminated to a supporting substrate. Suitable high reflectivity materials include, without limitation: Vikuiti™ Enhanced Specular Reflector (ESR) multilayer polymeric film available from 3M Company; a film made by laminating a barium sulfate-loaded polyethylene terephthalate film (2 mils thick) to Vikuiti™ ESR film using a 0.4 mil thick isooctylacrylate acrylic acid pressure sensitive adhesive, the resulting laminate film referred to herein as “EDR II” film; E-60 series Lumirror™ polyester film available from Toray Industries, Inc.; porous polytetrafluoroethylene (PTFE) films, such as those available from W. L. Gore & Associates, Inc.; Spectralon™ reflectance material available from Labsphere, Inc.; Miro™ anodized aluminum films (including Miro™ 2 film) available from Alanod Aluminum-Veredlung GmbH & Co.; MCPET high reflectivity foamed sheeting from Furukawa Electric Co., Ltd.; and White Refstar™ films and MT films available from Mitsui Chemicals, Inc. The back reflector may be substantially flat and smooth, or it may have a structured surface associated with it to enhance light scattering or mixing. Such a structured surface can be imparted (a) on the reflective surface of the back reflector, or (b) on a transparent coating applied to the reflective surface. In the former case, a highly reflecting film may be laminated to a substrate in which a structured surface was previously formed, or a highly reflecting film may be laminated to a flat substrate (such as a thin metal sheet, as with Vikuiti™ Durable Enhanced Specular Reflector-Metal (DESR-M) reflector available from 3M Company) followed by forming the structured surface such as with a stamping operation. In the latter case, a transparent film having a structured surface can be laminated to a flat reflective surface, or a transparent film can be applied to the reflector and then afterwards a structured surface imparted to the top of the transparent film.

The back reflector can be a continuous unitary (and unbroken) layer on which the light source(s) are mounted, or it can be constructed discontinuously in separate pieces, or discontinuously insofar as it includes isolated apertures, through which light sources can protrude, in an otherwise continuous layer. For example, strips of reflective material can be applied to a substrate on which rows of LEDs are mounted, each strip having a width sufficient to extend from one row of LEDs to another, and having a length dimension sufficient to span between opposed borders of the backlight's output area.

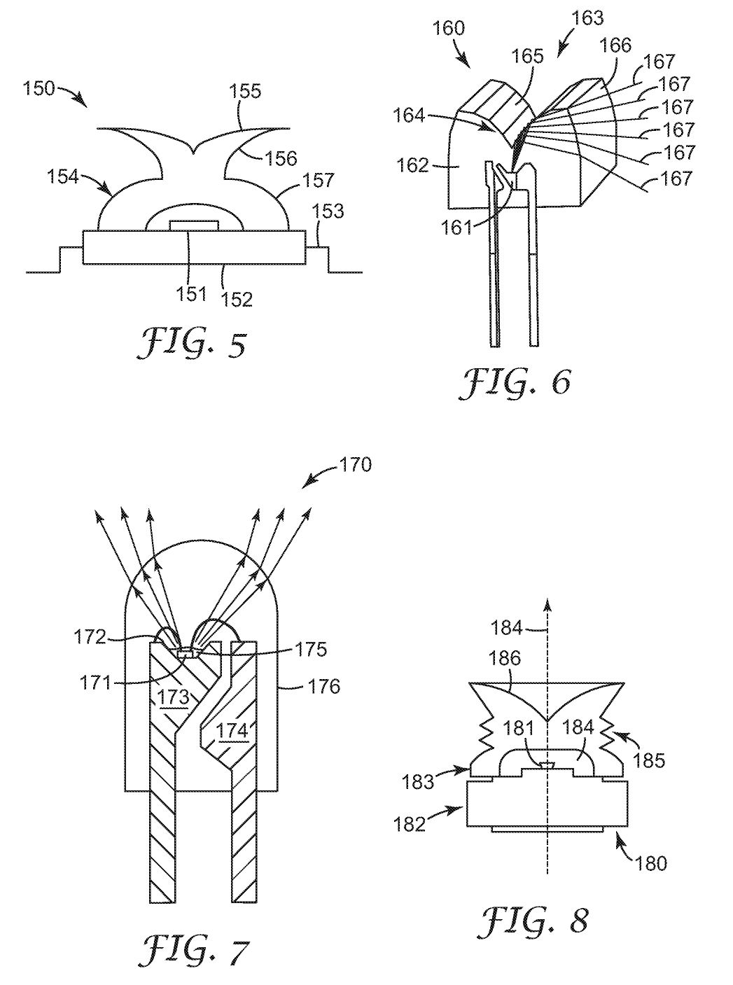

FIGS. 5-8 show views of some light sources that are useable in the disclosed backlights, but they are not intended to be limiting. The illustrated light sources comprise packaged LEDs. The light sources of FIGS. 5, 6, and 8 show side-emitting LED packages, where light from an LED die is reflected and/or refracted by an integral encapsulant or lens element to provide peak light emission in a generally lateral direction rather than forward along a symmetry axis of the source. The light source of FIG. 7 is forward emitting.

In FIG. 5, a light source 150 includes an LED die 151 carried by a frame 152 and electrically connected to leads 153. Leads 153 are used to electrically and physically connect the light source 150 to a circuit board or the like. A lens 154 is attached to frame 152. The lens 154 is designed such that light emitted into an upper section of the lens is totally internally reflected on an upper surface 155 such that it is incident on a bottom surface 156 of the upper section and refracted out of the device. Light emitted into a lower section 157 of the lens is also refracted out of the device. See also U.S. Patent Application Publication US 2004/0233665 (West et al.).

In FIG. 6, a light source 160 includes an LED die (not shown) mounted on a lead frame 161. A transparent encapsulant 162 encapsulates the LED die, lead frame 161, and a portion of the electrical leads. The encapsulant 162 exhibits reflection symmetry about a plane containing an LED die surface normal. The encapsulant has a depression 163 defined by curved surfaces 164. Depression 163 is essentially linear, centered on the plane of symmetry, and a reflective coating 165 is disposed on at least a portion of surface 164. Light emanating from the LED die reflects off reflective coating 165 to form reflected rays, which are in turn refracted by a refracting surface 166 of the encapsulant, forming refracted rays 167. See also U.S. Pat. No. 6,674,096 (Sommers).

In FIG. 7, a light source 170 includes an LED die 171 disposed in a recessed reflector area 172 of a lead frame 173. Electrical power is supplied to the source by the lead frame 173 and another lead frame 174, by virtue of wire bond connections from the lead frames to the LED die 171. The LED die has a layer of fluorescent material 175 over it, and the entire assembly is embedded in a transparent encapsulation epoxy resin 176 having a lensed front surface. When energized, the top surface of the LED die 171 produces blue light. Some of this blue light passes through the layer of fluorescent material, and combines with yellow light emitted by the fluorescent material to provide a white light output. Alternately, the layer of fluorescent material can be omitted so that the light source emits only the blue light (or another color as desired) produced by the LED die 171. In either case, the white or colored light is emitted in essentially a forward direction to produce peak light emission along a symmetry axis of the light source 170. See also U.S. Pat. No. 5,959,316 (Lowery).

In FIG. 8, a light source 180 has an LED die 181 supported by a package base 182. A lens 183 is coupled to base 182, and a package axis 184 passes through the center of base 182 and lens 183. The shape of lens 183 defines a volume 184 between LED die 181 and lens 183. The volume 184 can be filled and sealed with silicone, or with another suitable agent such as a resin, air or gas, or vacuum. Lens 183 includes a sawtooth refractive portion 185 and a total internal reflection (TIR) funnel portion 186. The sawtooth portion is designed to refract and bend light so that the light exits from lens 183 as close to 90 degrees to the package axis 184 as possible. See also U.S. Pat. No. 6,598,998 (West et al.).

Multicolored light sources, whether or not used to create white light, can take many forms in a backlight, with different effects on color and brightness uniformity of the backlight output area. In one approach, multiple LED dies (e.g., a red, a green, and a blue light emitting die) are all mounted in close proximity to each other on a lead frame or other substrate, and then encased together in a single encapsulant material to form a single package, which may also include a single lens component. Such a source can be controlled to emit any one of the individual colors, or all colors simultaneously. In another approach, individually packaged LEDs, with only one LED die and one emitted color per package, can be clustered together, the cluster containing a combination of packaged LEDs emitting different colors such as blue/yellow or red/green/blue. In still another approach, such individually packaged multicolored LEDs can be positioned in one or more lines, arrays, or other patterns.

Depending on the choice of light source, the back reflector, diverter, and other components of the backlight will be exposed to different amounts of UV radiation, with CCFL and HCFL sources emitting more UV radiation in general than LED sources. Hence, components of the backlight may incorporate UV absorbers or stabilizers, or may utilize materials selected to minimize UV degradation. If low UV-output sources such as LEDs are used to illuminate the backlight, UV absorbers and the like may not be necessary, and a wider selection of materials is available.

Unless otherwise indicated, all numbers expressing feature sizes, amounts, and physical properties used in the specification and claims are to be understood as being modified by the term “about.” Accordingly, unless indicated to the contrary, the numerical parameters set forth in the present specification and claims are approximations that can vary depending upon the desired properties sought to be obtained by those skilled in the art utilizing the teachings disclosed herein.

Various modifications and alterations of this invention will be apparent to those skilled in the art without departing from the scope and spirit of this invention, and it should be understood that this invention is not limited to the illustrative embodiments set forth herein. All U.S. patents and other patent and non-patent documents referred to herein are incorporated by reference, to the extent they are not inconsistent with the foregoing disclosure.

What is claimed is:

1. A direct-lit backlight having an output area, comprising:
a first and second light source disposed behind the output area, the first and second light sources being spaced apart from each other and each emitting at least a first light component towards the output area; and
a first diverter disposed between the light sources and the output area and having a first and second reflective surface;
wherein the first reflective surface is obliquely disposed to redirect at least some of the first light component away from the output area, and the second reflective surface is obliquely disposed to redirect at least some of a second light component propagating laterally relative to the output area towards the output area.

2. The backlight of claim 1, wherein the output area is a surface of a diffuser plate.

3. The backlight of claim 1, further comprising a back reflector and reflective side walls, the light sources disposed between the back reflector and the output area.

4. The backlight of claim 1, wherein the first and second light sources are part of a first row of light sources, and the diverter is elongated and oriented to extend parallel to the first row of light sources.

5. The backlight of claim 4, wherein the first light source emits light of a first color and the second light source emits light of a second color different from the first color.

6. The backlight of claim 5, wherein the first row of light sources further includes a third light source that emits light of a third color different from the first and second colors.

7. The backlight of claim 6, wherein the first, second, and third colors are selected from the group of red, green, and blue.

8. The backlight of claim 1, wherein the first and second light sources are LEDs.

9. The backlight of claim 8, wherein the LEDs are packaged to emit at least some light sideways out of the package.

10. The backlight of claim 1, where the first diverter comprises a reflective film, and the first and second reflective surfaces are opposed major surfaces of the reflective film.

11. The backlight of claim 1, wherein the first diverter comprises distinct first and second reflective films, the first reflective film comprising the first reflective surface and the second reflective film comprising the second reflective surface.

12. The backlight of claim 1, wherein the first and second reflective surfaces are flat.

13. The backlight of claim 1, wherein the first and second reflective surfaces reflect light specularly.

14. The backlight of claim 1, wherein the first and second reflective surfaces reflect light diffusely.

15. The backlight of claim 1, wherein the light source has an asymmetric cross-sectional shape.

16. The backlight of claim 1, wherein the first reflective surface is not transmissive.

17. The backlight of claim 1, wherein the first reflective surface is partially transmissive.

18. The backlight of claim 17, wherein the first reflective surface transmits 20% to 80% of normally incident, diffusely incident, or actually incident light.

19. The backlight of claim 1 in combination with a display panel.

20. The combination of claim 19, wherein the display panel comprises a liquid crystal display (LCD).

21. An LCD TV comprising the combination of claim 20.
